(19) United States
(12) Patent Application Publication
(10) Pub. No.: US 2002/0047984 A1
(43) Pub. Date: Apr. 25, 2002

(54) Eyeglass assembly

(76) Inventor: Johnson Tang, Taipei City (TW)

Correspondence Address: Ostrolenk Faber Gebb & Soffen LLP, 1180 Avenue of the Americas, New York, NY, 10036-8403, US

(21) Appl. No.: 09/740,349

(22) Filed: Dec. 18, 2000

(30) Foreign Application Priority Data
Oct. 25, 2000 (TW) 089218571

(51) Int. Cl. G02C 9/00; G02C 7/08

(52) U.S. Cl. 351/57; 351/58; 351/47

(57) ABSTRACT

An eyeglass assembly includes primary and auxiliary frames which can be superimposed upon each other in a transverse direction, and which respectively have two primary and two auxiliary lens mounting portions of such profiles so as to mate with each other. The mating primary and auxiliary lens mounting portions respectively have front and rear wall surfaces facing each other and formed with two concavities at two longitudinal sides such that pairs of magnetic members and magnetically attractive members are received therein. The magnetic and magnetically attractive members attract with each other in the transverse direction, thereby securing the auxiliary frame on the primary frame.

### BACKGROUND OF THE INVENTION

1. Field of the Invention

This invention relates to an eyeglass assembly, more particularly to an eyeglass assembly with a primary frame and an auxiliary frame attached to the primary frame by means of magnetic and magnetically attractive members.

2. Description of the Related Art

Referring to FIGS. 1 and 2, a conventional eyeglass assembly is shown to include a primary frame 6 and an auxiliary frame 7 for supporting primary and auxiliary lenses therein. The primary frame 6 has a pair of connecting arms 62 which are provided with two mounting seats 64 and two magnetic members 66 at a rear wall surface of the frame 6. The auxiliary frame 7 has a pair of connecting arms 72 which extend rearwardly and which are provided with two receiving seats 74 and two magnetic members 76 that are received in the receiving seats 74, respectively. When the auxiliary frame 7 faces and is superimposed upon the primary frame 6 in a transverse direction, the connecting arms 72 pass through the mounting seats 64 such that the magnetic members 76 can magnetically attract with the magnetic members 66 so as to secure the auxiliary frame 7 on the primary frame 6. However, it is required to provide the mounting and receiving seats 64,74 on the frames 6,7, and the magnetic members 66,76 are exposed outwardly of the frames 6,7, thereby resulting in an adversely affect on the appearance of the frames 6,7. In addition, the arrangement as such makes it inconvenient to assemble and disassemble the auxiliary frame 7 to and from the primary frame 6.

### SUMMARY OF THE INVENTION

The object of the present invention is to provide an eyeglass assembly which has a simple construction and which makes it convenient to assemble and disassemble an auxiliary frame to and from a primary frame, and in which magnetic members and magnetically attractive members are concealed in the primary and auxiliary frames so as to enhance the aesthetic appeal of the frames.

According to this invention, the eyeglass assembly includes primary and auxiliary frames for supporting primary and auxiliary lenses therein. The primary frame includes a pair of primary lens mounting portions which are aligned with and which are spaced apart from each other in a longitudinal direction. Each primary lens mounting portion has a first front wall surface, a first rear wall surface opposite to the first front wall surface in a transverse direction relative to the longitudinal direction, and an inner intersecting wall surface that interconnects the first front and rear wall surfaces for attaching one of the primary lenses. The first front wall surface includes proximate and distal ends opposite to each other in the longitudinal direction and relative to the other one of the primary lens mounting portions so as to support one of the primary lenses between the proximate and distal ends. The first front wall surface has first and second concavities which are formed in the proximate and distal ends respectively and each of which extends towards the first rear wall surface. A primary bridge portion extends in the longitudinal direction to interconnect the proximate ends of the primary lens mounting portions. A pair of temples are hinged to the distal ends of the primary lens mounting portions about an upright axis transverse to both the longitudinal and the transverse directions, and extend in the transverse direction. The auxiliary frame includes a pair of auxiliary lens mounting portions of such profiles as to mate with and be superimposed upon the primary lens mounting portions respectively in the transverse direction. Each auxiliary lens mounting portion has a second front wall surface, and a second rear wall surface opposite to the second front wall surface in the transverse direction and which can face the first front wall surface of the respective primary lens mounting portion. The second rear wall surface has third and fourth concavities which extend towards the second front wall surface and which can face and be aligned respectively with the first and second concavities of the respective primary lens mounting portion in the transverse direction. In each pair of the corresponding concavities, a magnetic member and a magnetically attractive member are received therein for magnetically attraction with each other in the transverse direction when the auxiliary frame is superimposed upon the primary frame, thereby securing the former on the latter.

### BRIEF DESCRIPTION OF THE DRAWINGS

Other features and advantages of the present invention will become apparent in the following detailed description of the preferred embodiments of the invention, with reference to the accompanying drawings, in which:

FIGS. 1 and 2 are top views of a conventional eyeglass assembly;

FIG. 3 is a front view of a primary frame of a preferred embodiment of an eyeglass assembly according to this invention;

FIG. 4 is a partly cross-sectional view of the primary frame shown in FIG. 3 taken along lines IV-IV thereof;

FIG. 5 is a front view of an auxiliary frame of the preferred embodiment;

FIG. 6 is a partly cross-sectional view of the auxiliary frame shown in FIG. 5 taken along lines VI-VI thereof;

FIG. 7 is a front view showing the primary and auxiliary frames connected to each other; and

FIG. 8 is a front view of an auxiliary frame of another preferred embodiment of an eyeglass assembly according to this invention.

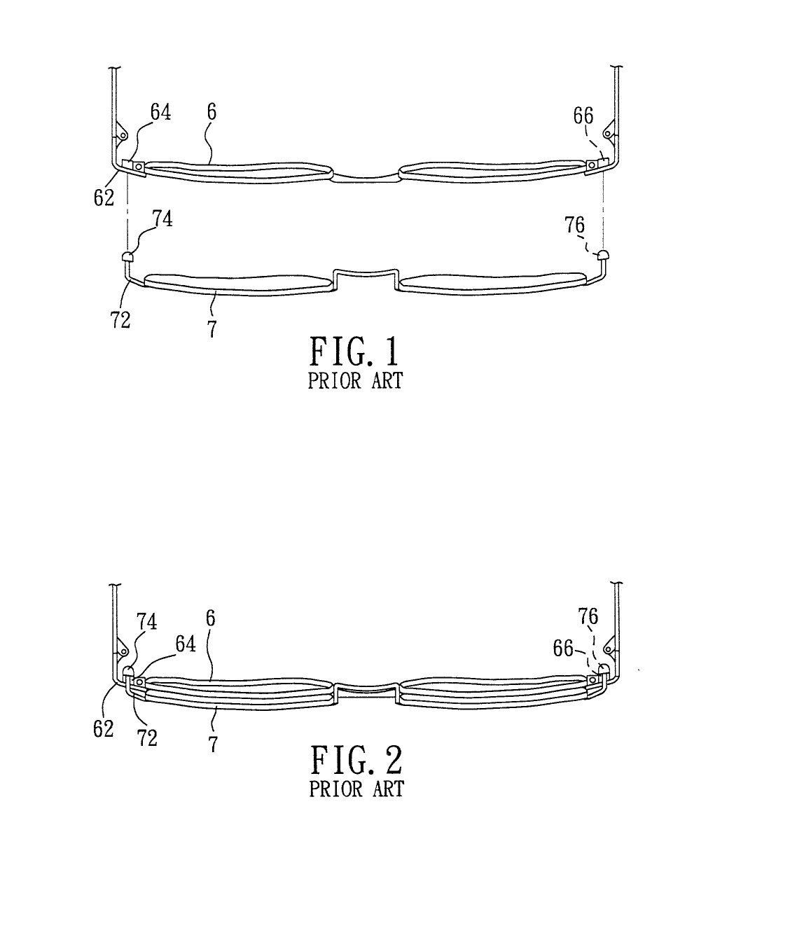

### DETAILED DESCRIPTION OF THE PREFERRED EMBODIMENTS

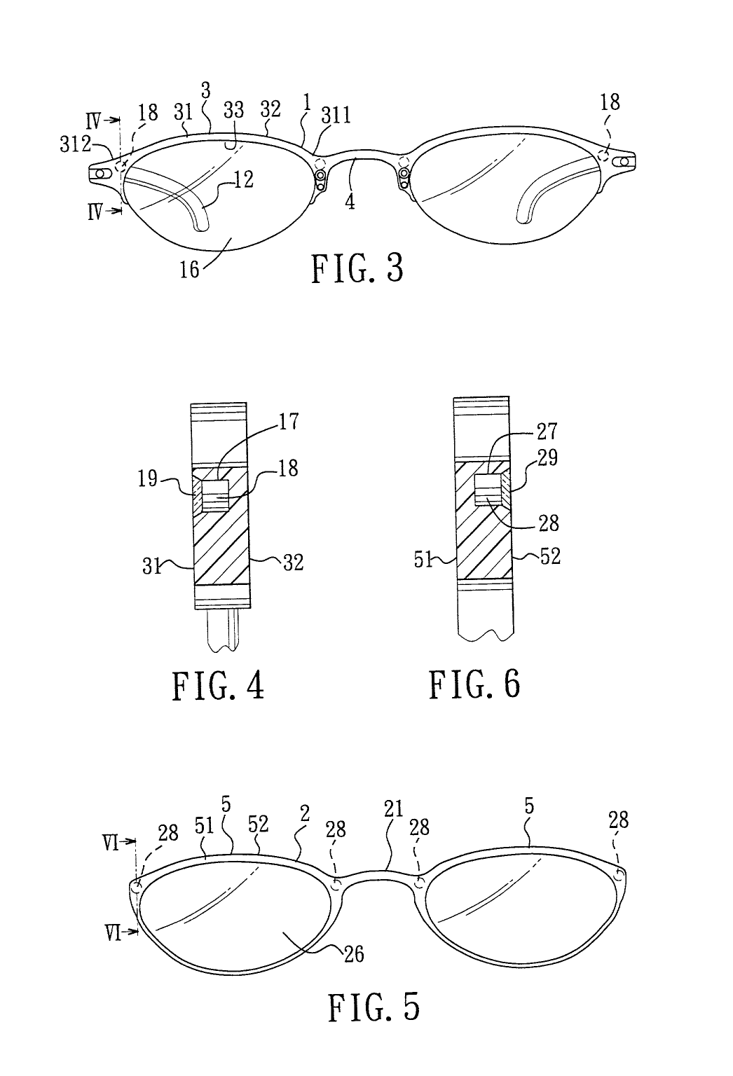

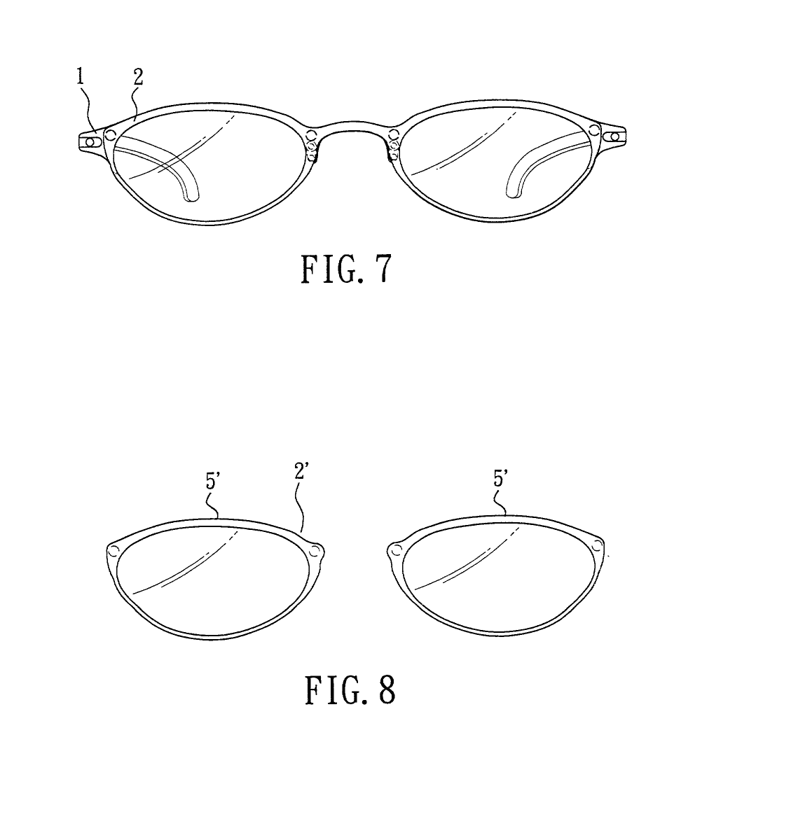

Referring to FIGS. 3 to 7, the preferred embodiment of the eyeglass assembly according to the present invention is shown to comprise a primary frame 1 and an auxiliary frame 2 for supporting primary and auxiliary lenses 16,26 therein, respectively.

The primary frame 1 includes a pair of primary lens mounting portions 3 which are aligned with and which are spaced apart from each other in a longitudinal direction. Each primary lens mounting portion 3 has a first front wall surface 31, a first rear wall surface 32 opposite to the first front wall surface 31 in a transverse direction relative to the longitudinal direction, and an inner intersecting wall surface 33 which interconnects the first front and rear wall surfaces 31,32 and which is adapted for attaching one of the primary lenses 16. The first front wall surface 31 includes proximate and distal ends 311,312 opposite to each other in the longitudinal direction and relative to the other one of the primary lens mounting portions 3 so as to support one of the primary lenses 16 between the proximate and distal ends 311,312. In addition, the first front wall surface 31 has first and second concavities 17 which are formed in the proximate and distal ends 311,312 respectively and each of which extends towards the first rear wall surface 32. Each concavity 17 may be circular or polygonal in shape. A primary bridge portion 4 extends in the longitudinal direction to interconnect the proximate ends 311 of the primary lens mounting portions 3 and is adapted to rest on a wearer's nose. The primary frame 1 further includes a pair of temples 12, each of which includes a front end that is hinged to the distal end 312 of a respective one of the primary lens mounting portions 3 about an upright axis transverse to both the longitudinal and the transverse directions, and a rear end that extends from the front end in the transverse direction and that is adapted to fit over the wearer's ear.

The auxiliary frame 2 includes a pair of auxiliary lens mounting portions 5 of such profiles as to mate with and be superimposed upon the primary lens mounting portions 3 respectively in the transverse direction. Each auxiliary lens mounting portion 5 has a second front wall surface 51, and a second rear wall surface 52 opposite to the second front wall surface 51 in the transverse direction. The second rear wall surface 52 faces the first front wall surface 31 of the respective primary lens mounting portion 3 when the auxiliary lens mounting portions 5 are superimposed upon the primary lens mounting portions 3, respectively. The second rear wall surface 52 has third and fourth concavities 27 which extend towards the second front wall surface 51 and which face and which are aligned respectively with the first and second concavities 17 of the respective primary lens mounting portion 3 in the transverse direction. An auxiliary bridge portion 21 extends in the longitudinal direction to interconnect the auxiliary lens mounting portions 5. The auxiliary bridge portion 21 faces and is aligned with the primary bridge portion 4 in the transverse direction when the auxiliary and primary frames 2,1 are superimposed upon each other.

Two pairs of first magnetic members 18 and first magnetically attractive members 28 are received in the first concavities 17 and the third concavities 27, respectively. As such, when the auxiliary and primary frames 2,1 are superimposed upon each other, the first magnetic members 18 and the corresponding first magnetically attractive members 28 magnetically attract with each other.

Two pairs of second magnetic members 18 and second magnetically attractive members 28 are received in the second concavities 17 and the fourth concavities 27, respectively. As such, when the auxiliary and primary frames 2,1 are superimposed upon each other, the second magnetic members 18 and the corresponding second magnetically attractive members 28 magnetically attract with each other. Preferably, the first and second magnetic members 18 and the first and second magnetically attractive members 28 are permanent magnets.

In this embodiment, a filling member 19,29 is used to fill each concavity 17,27 when the respective one of the magnetic members 18 and the magnetically attractive members 28 has been received in the concavity 17,27 so as to embed and conceal the respective one of the magnetic members 18 and the magnetically attractive members 28 in the concavity 17,27. The filling member 19,29 is advantageously flush with the corresponding one of the first front wall surface 31 and the second rear wall surface 51. In addition, the filling member 19,29 is made of resin material or a metal powder, and has the same color as that of the primary and auxiliary frames 1,2 so as not to affect adversely the appearance of the frames 1,2. Alternatively, the magnetic members 18 and the magnetically attractive members 28 may be flush with the corresponding one of the first front wall surface 31 and the second rear wall surface 51 without provision of the filling members 19,29.

As illustrated, by means of the magnetic members 18 and the magnetically attractive members 28, the auxiliary frame 2 can be conveniently superimposed upon and secured on the primary frame 1 in the transverse direction.

As shown in FIG. 8, the auxiliary frame 2′ of the second preferred embodiment according to this invention is shown to have the auxiliary lens mounting portions 5′ thereof in the form of two separate components, i.e. they are not interconnected by a bridge portion, such that the weight of the auxiliary frame 2′ can be reduced.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. An eyeglass assembly comprising:
a primary frame for supporting primary lenses therein, and including
a pair of primary lens mounting portions which are aligned with and which are spaced apart from each other in a longitudinal direction, each of said primary lens mounting portions having a first front wall surface, a first rear wall surface opposite to said first front wall surface in a transverse direction relative to the longitudinal direction, and an inner intersecting wall surface interconnecting said first front and rear wall surfaces and adapted for attaching one of the primary lenses, said first front wall surface including proximate and distal ends opposite to each other in the longitudinal direction and relative to the other one of said primary lens mounting portions and adapted to support one of the primary lenses between said proximate and distal ends, said first front wall surface having first and second concavities which are formed in said proximate and distal ends respectively and each of which extends towards said first rear wall surface,
a primary bridge portion extending in the longitudinal direction to interconnect said proximate ends of said primary lens mounting portions and adapted to rest on a wearer's nose, and
a pair of temples, each including a front end hinged to said distal end of a respective one of said primary lens mounting portions about an upright axis transverse to both the longitudinal and the transverse directions, and a rear end extending from said front end in the transverse direction and adapted to fit over the wearer's ear;
an auxiliary frame for supporting auxiliary lenses therein, and including a pair of auxiliary lens mounting portions of such profiles as to mate with and be superimposed upon said primary lens mounting portions respectively in the transverse direction, each of said auxiliary lens mounting portions having a second front wall surface, and a second rear wall surface opposite to said second front wall surface in the transverse direction and facing said first front wall surface of a respective one of said primary lens mounting portions when said auxiliary lens mounting portions are superimposed upon said primary lens mounting portions respectively, said second rear wall surface having third and fourth concavities which extend towards said second front wall surface and which face and which are aligned respectively with said first and second concavities of the respective one of said primary lens mounting portions in the transverse direction when said auxiliary lens mounting portions are superimposed upon said primary lens mounting portions respectively;
two pairs of first magnetic members and first magnetically attractive members, said first magnetic member of each pair being received in one of said first and third concavities, said first magnetically attractive member of each pair being received in the other one of said first and third concavities so as to magnetically attract with said first magnetic member in said pair when said auxiliary lens mounting portions are superimposed upon said primary lens mounting portions respectively; and
two pairs of second magnetic members and second magnetically attractive members, said second magnetic member of each pair being received in one of said second and fourth concavities, said second magnetically attractive member of each pair being received in the other one of said second and fourth concavities so as to magnetically attract with said second magnetic member in said pair when said auxiliary lens mounting portions are superimposed upon said primary lens mounting portions respectively.

2. The eyeglass assembly as claimed in claim 1, wherein each of said first and second magnetic members and said first and second magnetically attractive members is flush with a corresponding one of said first front wall surface and said second rear wall surface.

3. The eyeglass assembly as claimed in claim 1, further comprising eight filling members respectively filled in said first, second, third, and fourth concavities when said magnetic members and said magnetically attractive members have been received in said concavities so as to embed said magnetic members and said magnetically attractive members in said concavities, said filling members being flush with a corresponding one of said first front wall surface and said second rear wall surface.

4. The eyeglass assembly as claimed in claim 3, wherein each of said filling members is made of a resin material and has the same color as that of said primary and auxiliary frames.

5. The eyeglass assembly as claimed in claim 3, wherein each of said filling members is made of metal powder and has the same color as that of said primary and auxiliary frames.

6. The eyeglass assembly as claimed in claim 1, wherein each of said first and second magnetic members is a permanent magnet.

7. The eyeglass assembly as claimed in claim 1, wherein each of said first and second magnetically attractive members is a permanent magnet.

8. The eyeglass assembly as claimed in claim 1, wherein said auxiliary frame further includes an auxiliary bridge portion which extends in the longitudinal direction to interconnect said auxiliary lens mounting portions and which faces and which is aligned with said primary bridge portion in the transverse direction when said auxiliary frame is superimposed upon said primary frame.
